(19) United States
(12) Patent Application Publication
(10) Pub. No.: US 2026/0016566 A1
(43) Pub. Date: Jan. 15, 2026

(54) RADAR SYSTEM

(71) Applicant: Infineon Technologies AG, Neubiberg (DE)

(72) Inventors: Andre ROGER, München (DE); Markus BICHL, Feldkirchen-Westerham (DE); Mayeul JEANNIN, Augsburg (DE); Ljudmil ANASTASOV, München (DE); Dian Tresna NUGRAHA, Bandung (ID); Simon ACHATZ, Poing (DE); Farhan Bin KHALID, München (DE)

(21) Appl. No.: 19/254,695

(22) Filed: Jun. 30, 2025

(30) Foreign Application Priority Data
Jul. 15, 2024 (DE) 102024120156.8

(51) Int. Cl. G01S 7/40

(52) U.S. Cl. CPC G01S 7/4008

(57) ABSTRACT

A radar system includes a first circuit that includes a transmission channel configured to transmit an RF transmit signal, and a reception channel configured to receive an RF radar signal, which is based on the RF transmit signal, and to provide a digital radar signal, which is based on the received RF radar signal. The radar system further includes memory for storing first and second calibration information for the first circuit and a first calibration circuit that is configured to update the first calibration information based on the digital radar signal, and a digital signal processor configured to receive, via a digital communication link, the digital radar signal, transform the digital radar signal into the Doppler domain to obtain transformed radar data, and determine calibration data based on the transformed radar data and to cause an update of the stored second calibration information based on the calibration data.

### CROSS-REFERENCE TO RELATED APPLICATION

This application claims priority to Germany Patent Application No. 102024120156.8 filed on Jul. 15, 2024, the content of which is incorporated by reference herein in its entirety.

### TECHNICAL FIELD

The present disclosure relates to the field of radar sensors, in particular a concept for phase calibration in RF frontends of radar systems.

### BACKGROUND

Radar sensors can be found in numerous sensing applications in which distances and velocities of objects are to be measured. In the automotive industry, there is an increasing demand for radar sensors that may be used in so-called advanced driver-assistance systems (ADAS). Examples of advanced driver assistive systems include “adaptive cruise control” (ACC) and “radar cruise control” systems. Such systems may be used to automatically adjust the speed of an automobile so as to maintain a safe distance from other automobiles driving ahead. Other examples of advanced driver assistive system are blind-spot monitors, which may employ radar sensors to detect other vehicles in the blind spot of a vehicle. Particularly autonomous cars may use numerous sensors, such as radar sensors, to detect and locate various objects in their surroundings. Information about the position and velocity of objects in the area of an autonomous car is used to help navigate safely.

Modern radar systems make use of highly integrated RF circuits which may incorporate all core functions of an RF font-end of a radar transceiver in one single package (single chip transceiver). Such RF front-ends usually include, inter alia, a local RF oscillator (LO), power amplifiers (PA), low-noise amplifiers (LNA), and mixers. Frequency-modulated continuous-wave (FMCW) radar systems use radar signals whose frequency is modulated by ramping the signal frequency up and down. Such radar signals are often referred to as “chirp signals” or simply as “chirps”. In case of linear chirp signals the term “LFM signals” is sometimes used, wherein LFM stands for “linear frequency modulation”. A radar sensor usually radiates sequences of chirps using one or more antennas, and the radiated signal is backscattered by one or more objects (referred to as radar targets) located in the “field of view” of a radar sensor. The backscattered signals (radar echoes) are received and processed by the radar sensor. The detection of the radar targets is usually accomplished using digital signal processing. Other modulation techniques may be used instead of FM. One alternative are, for example, phase-modulated continuous-wave (PMCW) radar systems. Radar systems with a plurality of transmission and reception channels may be distributed over several chips.

In order to enable a precise detection and localization of radar targets, modern radar systems may include functions that allow phase calibration, e.g., a calibration of the phases of the radiated RF signals. During the calibration process, phases (relative to the phase of a reference signal) may be measured at the RF output port (antenna port) of each transmission channel. Modern radar applications such as, for example, in autonomous cars, require radar systems with increased sensitivity and resolution, and currently known calibration concepts may be insufficient to meet the need for high sensitivity and resolution. The inventors have thus set themselves the objective to improve existing calibration concepts currently used in radar systems.

### SUMMARY

The mentioned objective is achieved by the radar system of claim 1 and the method of claim 12. Various examples and further developments are covered by the dependent claims.

According to one example implementation, the radar system includes a first circuit that includes a transmission channel and a reception channel. The transmission channel is configured to transmit an RF transmit signal and the reception channel is configured to receive an RF radar signal, which is based on the RF transmit signal, and to provide a digital radar signal, which is based on the received RF radar signal. The system further includes memory for storing first and second calibration information for the first circuit and a first calibration circuit that is configured to update the first calibration information based on the digital radar signal. The system further includes a digital signal processor configured to receive, via a digital communication link, the digital radar signal, and to transform the digital radar signal into the Doppler domain to obtain transformed radar data. The digital signal processor is further configured to determine calibration data based on the transformed radar data and to cause an update of the stored second calibration information based on the calibration data.

According to another implementation, the method includes storing first and second calibration information for a first circuit of a radar system in a memory of the radar system, wherein the first circuit includes a transmission channel and a reception channel. The transmission channel transmits an RF transmit signal, whereas the reception channel receives an RF radar signal, which is based on the RF transmit signal, and provides a digital radar signal. The method further includes updating the first calibration information based on the digital radar signal using a first calibration circuit, and transmitting, via a digital communication link, the digital radar signal to a digital signal processor, which transforms the digital radar signal into the Doppler domain to obtain transformed radar data. Moreover, the method includes determining, by the digital signal processor, calibration data based on the transformed radar data and causing an update of the second calibration information stored in the memory based on the calibration data.

### BRIEF DESCRIPTION OF THE DRAWINGS

The implementation can be better understood with reference to the following drawings and descriptions. The components in the figures are not necessarily to scale; instead emphasis is placed upon illustrating the principles of the implementation. In the figures, like reference numerals designate corresponding parts. In the drawings:

FIG. 1 is a sketch illustrating the operating principle of an FMCW radar system for distance and/or velocity measurement.

FIG. 2 includes two timing diagrams illustrating the frequency modulation of the RF signal used in FMCW radar systems.

FIG. 3 is a block diagram illustrating the basic structure of an FMCW radar device.

FIG. 4 is a circuit diagram illustrating one example of a reception channel of a radar sensor.

FIG. 5 illustrates an example of a radar system with an internal (integrated within the MMIC) calibration loop.

FIG. 6 illustrates an implementation of a radar system with a first (internal) calibration loop and a second (external) calibration loop.

FIG. 7 is a flow chart illustrating one implementation of a method for calibrating the system of FIG. 6.

### DETAILED DESCRIPTION

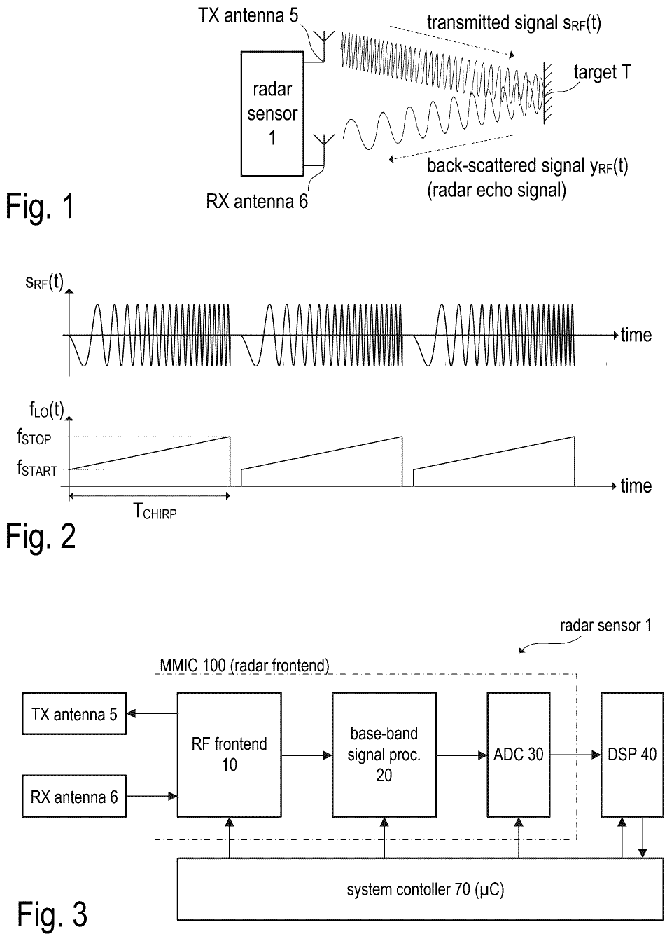

FIG. 1 illustrates the generic structure of an FMCW radar sensor 1. In the present example, separate transmission (TX) and reception (RX) antennas 5 and 6, respectively, are used (bistatic or pseudo-monostatic radar configuration). However, it is noted that a shared antenna may also be used, so that the reception antenna and the transmission antenna are physically the same (monostatic radar configuration) for a specific pair of RX and TX channels. During operation, the transmission antenna 5 (quasi-) continuously radiates an RF signal s_{RF}(t) which is frequency-modulated, for example, by a saw-tooth-shaped signal in case of an FMCW radar system. When the radiated signal s_{RF}(t) is back-scattered at an object T, which may be located in the radar channel within the measurement range of the radar device (e.g., within the radar system's “field of view”), the back-scattered signal y_{RF}(t) is received by the reception antenna 6. The object T is usually referred to as “radar target”.

In a more general example, more than one target may be in the field of view of a radar system, and an antenna array may be used instead of a single RX antenna. Similarly, an antenna array may be used instead of a single TX antenna. Using multiple RX and TX antennas in a multi-channel radar system allows for the measurement of the angle of incidence of a radar echo, usually referred to as direction of arrival (DoA). A precise measurement of the direction of arrival is important for many applications, and thus most radar sensors will make use of antenna arrays. To keep the drawings simple, only one TX antenna and one RX antenna (and respective TX and RX channels) are shown in the figures. It is understood that the concepts described herein are readily applicable to multi-channel radar sensors with antenna arrays, as well. Such radar systems are also referred to as multiple input multiple output (MIMO) systems.

FIG. 2 illustrates the mentioned conventional frequency-modulation of the signal s_{RF}(t). As shown in the top diagram of FIG. 2, the signal s_{RF}(t) is composed of a sequence of “chirps”, e.g., sinusoidal waveforms with increasing (up-chirp) or decreasing (down-chirp) frequency. In the present example, the instantaneous frequency f_{LO}(t) of a chirp increases linearly from a start frequency f_{START} to a stop frequency f_{STOP} within a defined time span T_{CHIRP} (see bottom diagram of FIG. 2). Such a chirp is also referred to as a linear frequency ramp. A linear frequency-modulated (LFM) signal with a sequence of three identical linear frequency ramps is illustrated in FIG. 2. It is noted, however, that the parameters f_{START}, f_{STOP}, T_{CHIRP} as well as the pause between the individual frequency ramps may vary dependent on the actual configuration of the radar system and may also vary during operation of the radar system. In practice, the frequency variation may be, for example, linear (linear chirp, frequency ramp), exponential (exponential chirp) or hyperbolic (hyperbolic chirp). It is noted that frequency modulation is not the only type of modulation that can be used in radar systems. For example some radar systems may use phase modulation. Such systems are called PMCW (phase-modulated continuous-wave) radar systems. Although FMCW radar systems are shown in the figures, it is nevertheless understood that the implementations described herein are not limited to FMCW radar devices or systems. Unmodulated CW signals may be used during a calibration process.

Before discussing the implementations in more detail, an example generic structure of a radar system is described. FIG. 3 is a block diagram that illustrates the structure of an example radar sensor/system 1. At least one transmission antenna 5 (TX antenna(s)) and at least one reception antenna 6 (RX antenna(s)) are connected to an RF frontend 10, which may be integrated in a semiconductor chip 100, usually referred to as monolithic microwave integrated circuit (MMIC). The RF frontend 10 may include all of the circuit components needed for RF signal processing. Such circuit components may include, for example, a local oscillator (LO), RF power amplifiers, low noise amplifiers (LNAs), directional couplers such as rat-race-couplers or circulators, and mixers for the down-conversion of RF signals (e.g., the received signal y_{RF}(t), see FIG. 1) into the baseband or IF-band.

As mentioned, antenna-arrays may be used instead of single antennas. The depicted example shows a bistatic (or pseudo-monostatic) radar system, which has separate RX and TX antennas. In the case of a monostatic radar system, a single antenna or a single antenna array may be used for both, receiving and transmitting electromagnetic (radar) signals. In this case a directional coupler (e.g., a circulator) may be used to separate RF signals to be transmitted to the radar channel from RF signals received from the radar channel.

In the case of an FMCW radar sensor, the RF signals radiated by the TX antenna 5 may be in a range of between approximately 20 GHz (e.g., 24 GHz) and 100 GHz (e.g., about 77-82 GHz in automotive applications). As mentioned, the RF signal received by the RX antenna 6 includes the radar echoes, e.g., the signals that have been back-scattered at the radar target(s). The received RF signal y_{RF}(t) is down-converted into the base band and is further processed in the baseband using analog signal processing (see FIG. 3, baseband signal processing chain 20), which basically includes filtering and amplification of the baseband signal, which is output by the RF frontend 10, and thus determines the bandwidth of the received signal.

The baseband signal is finally digitized using one or more analog-to-digital converters 30 and is then further processed in the digital domain (see FIG. 3, digital signal processing chain implemented, e.g., in digital signal processing circuit 40). The overall system and its operation are controlled by a system controller 70, which may be, at least partly, implemented by a processor which can execute appropriate software/firmware. The processor may be included, e.g., in a microcontroller, a digital signal processor, or the like. The digital signal processing (DSP) circuit 40 may be part of the system controller 70 or separate therefrom. The digital signal processing circuit 40 may be partly implemented using hard-wired or one-time programmable logic circuitry and partly using a processor executing software (firmware). Alternatively, the digital signal processing circuit may be substantially implemented using a processor programmed with software/firmware to perform the functions described herein.

It is noted that the components shown in FIG. 3 may, in some examples, be integrated in a single semiconductor chip. For example, the RF frontend 10 and the analog baseband signal processing chain 20 and, in some examples, the ADC 30, the signal processor 40 and the system controller 70 may be integrated into a single MMIC to form a single chip radar system. However, the components may also be distributed among two or more integrated circuits. In some implementation, some parts of the processing circuit 40 are integrated in the MMIC 100 while other parts are integrated in one or more other chips. Also the system controller 70 may be integrated in a separate chip. In some examples, some parts/functions of the system controller 70 may be integrated in the MMIC 100 and/or the processing circuit 40. Particularly MIMO systems with a larger number of RX/TX channels may include several MMICs 100 coupled to the system controller 70 and the processing circuit 40.

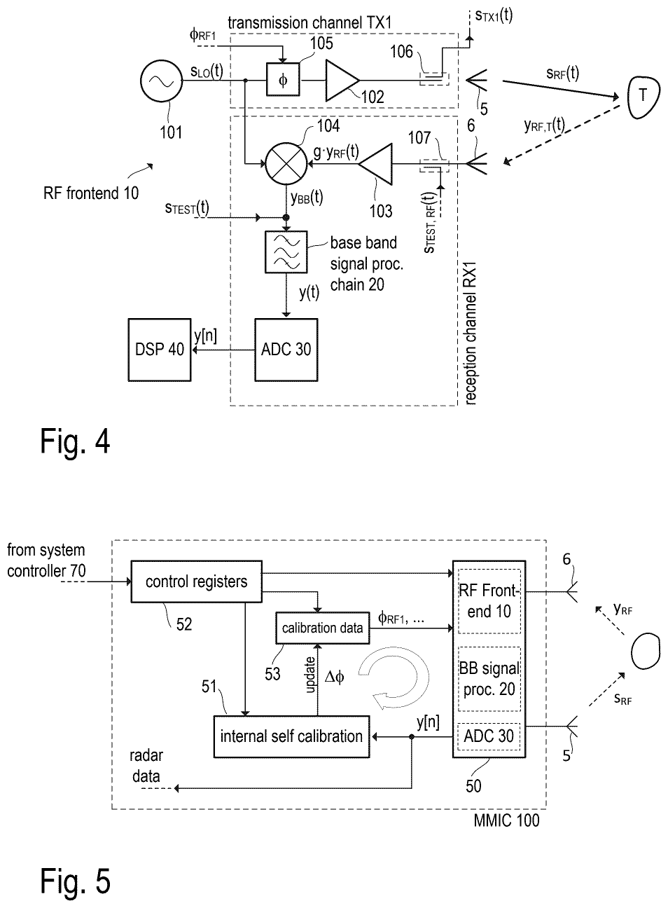

FIG. 4 illustrates one example of the RF frontend 10, which may be included in a radar MMIC of a radar system such as the radar sensor shown in FIG. 3. It is noted that FIG. 4 is a simplified circuit diagram illustrating the basic structure of an RF frontend. Actual implementations, which may depend on the application, may be significantly more complex. In particular, many practical implementations include multiple reception and transmission channels, wherein only one reception channel and one transmission channel is shown in the depicted example in order to keep the illustration simple.

The RF frontend 10 includes a local oscillator (LO) 101 that generates a RF signal s_{LO}(t), which may be frequency-modulated as explained above with reference to FIG. 2. The signal s_{LO}(t) is also referred to as LO signal. In some situations (e.g., during some calibration processes), the LO signal may be an unmodulated continuous-wave (CW) signal. In radar applications, the LO signal is usually in the SHF (Super High Frequency) or the EHF (Extremely High Frequency or millimeter-wave) band, e.g., between 76 GHz and 82 GHz in automotive applications.

The LO signal s_{LO}(t) is processed in the transmit signal path TX1 (transmission channel, TX channel), as well as in the receive signal path RX1 (reception channel, RX channel). The transmit signal s_{RF}(t), which is radiated by the TX antenna 5, is generated by amplifying the (e.g., frequency-modulated) LO signal s_{LO}(t), e.g., using an RF power amplifier 102. The output of the amplifier 102 is coupled to the TX antenna 5 e.g., via strip lines, a coupler (see, e.g., coupler 106), matching network, etc. (not shown in FIG. 4). The transmission channel TX1 depicted in FIG. 4 may also include a phase shifter 105, which is configured to tune the phase of the RF signal s_{RF}(t) radiated by the TX antenna 5. In the present example, the phase shifter 105 imposes a phase offset ϕ_{RF1} onto the LO signal s_{LO}(t) before the amplification. In some implementations, the (optional) directional coupler 106 may output a scaled version of the transmit signal s_{RF}(t) as test signal s_{TX1}(t)), which may be used for output phase monitoring and calibration. In one example, the signal s_{TX1}(t)), or a signal derived therefrom, may be fed into the RF signal path of an RX channel (see test signal s_{TEST,RF}(t)) during a calibration procedure.

The received signal y_{RF}(t), which is provided by the RX antenna 6, is supplied to a mixer 104. In the present example, the received signal y_{RF}(t) (e.g., the antenna signal) is pre-amplified by RF amplifier 103 (e.g., by a low-noise amplifier, LNA, with gain g), so that the mixer receives the amplified signal g·y_{RF}(t) at its RF input. The mixer 104 further receives the LO signal s_{LO}(t) at its reference input and is configured to down-convert the amplified antenna signal g·y_{RF}(t) into the base band. The resulting baseband signal at the mixer output is denoted as y_{BB}(t).

The baseband signal y_{BB}(t) is further processed by the analog baseband signal processing chain 20 (see also FIG. 3), which basically includes one or more filters (e.g., a band-pass or a low-pass) for removing undesired side bands and image frequencies, as well as one or more amplifiers. The analog output signal of the baseband signal processing chain 20 is denoted as y(t) and may be supplied to an analog-to-digital converter (ADC) 30 (see also FIG. 3).

The digital signal y[n] output by the ADC 30 is referred to as digital radar signal and includes the digital radar data. The digital radar signal may be supplied to a processor such as digital signal processing circuit 40, which is configured to further process the digital radar signal, e.g., by applying algorithms summarized under the term Range/Doppler processing. The digital signal processing circuit may also perform functions to test different components of the radar system (self-test routines). The implementation of the circuit components shown in FIG. 4 are as such known in the field of radar sensors and is thus not explained in more detail. Together, the transmission channels and reception channels can be referred to as “radar frontend” 50.

During a self-test or calibration procedure an RF test signal s_{TEST,RF}(t) may be fed into the RF signal path of the reception channel RX1, e.g., by using a coupler 107. The RF test signal s_{TEST,RF}(t) may be generated based on the LO signal s_{LO}(t). In one specific example, the signal s_{TX1}(t)) branched off at the output of a TX channel using coupler 105 may be used as RF test signal s_{TEST,RF}(t). Alternatively, the radar frontend may include a separate circuit configured to generate the RF test signal s_{TEST,RF}(t) based on the LO signal. During the calibration procedure, the digital radar signal y[n] will represent the RF test signal s_{TEST,RF}(t). For example, the phase of the digital radar signal y[n] depends on the phase of the RF test signal s_{TEST}(t) and the characteristics of the circuit components of the RX channel. Various concepts for testing/calibrating radar frontends are as such known and thus not explained herein in more detail. For example, reference is made to U.S. Pat. No. 9,331,797 B2. Alternatively, a test signal may be fed into the base band signal processing chain 20 instead (instead of feeding an RF test signal into the RF signal path).

The example of FIG. 5 illustrates the concept of an “internal” phase calibration process, wherein the term “internal” indicates that the calibration process is performed within the MMIC 100. FIG. 5 illustrates a radar MMIC 100 with a radar frontend 50 that includes a plurality of TX channels and RX channels. The RF components and the analog base band processing in the RX channels are summarized as radar frontend 50, wherein each physical RX channel may include a base band signal processing chain 20 and an ADC 30 as discussed above.

As shown in FIG. 5, the MMIC 100 includes memory 53 for storing calibration information for the radar frontend 50. The calibration information may include phase values such as, for example, the value ϕ_{RF1}, ϕ_{RF2}, ϕ_{RF3}, etc. which may be used as input for the phase shifters included in the different transmit channels (see phase shifter 105 in FIG. 4). The stored calibration information may be retrieved from a set of control registers 52, wherein the data stored in the control registers 52 may be provided by an external circuit (e.g., the system controller 50 and/or the signal processing circuit 40, see FIG. 3).

The MMIC 100 further includes a calibration circuit 51 that is configured to update the calibration information based on the signal(s) received by the analog baseband signal processing chain 20. The signal(s) may be RF signal(s) fed into the RF frontend (e.g., using a coupler) and/or may be baseband signals fed into the analog baseband signal processing chain 20. In the depicted implementation, the calibration circuit 51 updates the calibration information stored in the memory 53 based on the digital radar signal(s) y[n] (digitized base-band signal) provided by the radar frontend 50, thereby forming an internal (e.g., residing within the MMIC) calibration loop.

In the internal calibration loop, the signal(s) used for calibration are processed only within the MMIC to obtain measurement data, which is then used for the calibration. In other words, the signals used for internal calibration do not leave the MMIC. The MMIC 100 (in particular the frontend 50) is configured to transmit radar signals s_{RF}—using the calibration information—to one or more targets and receive radar signals (radar echoes) y_{RF} from the target(s) to determine distance (range), velocity and/or direction of arrival of the radar target(s).

In the internal calibration loop, the calibration circuit 51 receives the digital radar signal y[n] and determines one or more signal parameters from the digital radar signal y[n]. The one or more signal parameters may include, e.g., a phase value and/or an amplitude value. The signal parameter(s) may be associated with a specific frequency or frequency range of the LO signal s_{LO}(t). In one implementation, the calibration circuit 51 receives the digital radar signals y[n] of all physical RX channels and determines one or more signal parameters based thereon. Each of these signal parameter(s) may be associated with a particular combination of RX channel and TX channel. For example, the digital radar signal y[n] received by a specific RX channel RX3 may represent the RF radar signal transmitted by TX channel TX2. For this specific combination RX3/TX2 (amongst various other combinations) a phase value may be determined by the calibration circuit 51. The MMIC 100 is configured to transmit RF radar signals SRF via the respective TX channels based on the calibration information to radar targets located in the system's field of view and to receive radar signals from the radar targets to determine range, velocity and/or direction of arrival thereof.

It is clear that the signal parameters determined by the calibration circuit 51 depends on the calibration information stored in the memory 53. For example, referring to FIGS. 4 and 5, it is self-evident from the depicted circuits that a phase value, which can be determined from the digital signal y[n] of reception channel RX1, will depend on the phase shift ϕ_{RF1} caused by the phase shifter 105 in the transmission channel TX1. As mentioned, this phase shift ϕ_{RF1} is included in (or depends on) the calibration information stored in the memory 53 shown in FIG. 5. In some implementations, the amplitude/phase value, which can be determined from the digital signal y[n] of reception channel RX1, is determined by the known amplitude/phase of an RF test signal fed into the RF frontend (or a baseband test signal fed into the analog base band processing chain of the respective channel). The calibration circuit 51 may, for example, determine signal parameter such as phase value(s) from the digital output signals y[n] of the reception channels and compare the determined signal parameters with defined target values (expected values). Based on this comparisons the calibration circuit can update the calibration information stored in the memory 53 (e.g., the phase value ϕ_{RF1} for phase shifter 105 in the depicted example) thereby closing the calibration loop. The calibration process 51, by which the calibration information stored in the memory 53 is updated, may be an iterative process.

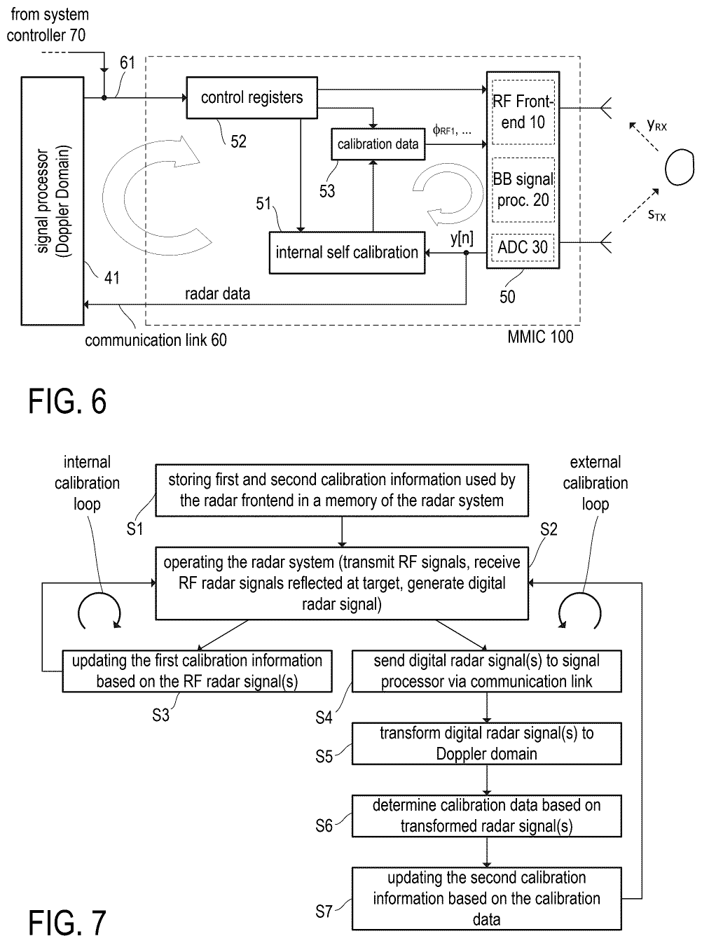

FIG. 6 illustrates one implementation of a radar system with an additional (external) calibration loop and therefore allows either to use a two-stage calibration procedure or to select either the internal or the external calibration loop.

The MMIC 100 of FIG. 6 is the same as in the example of FIG. 5 and reference is made to the respective description above. Accordingly, the MMIC 100 includes the calibration circuit 51 that is configured to update calibration information based on the signal(s) received by the analog baseband signal processing chain 20 as outlined above. In addition thereto, the system of FIG. 6 includes an additional functional block 41, which is used in an second (external) calibration loop and which may be implemented e.g., in the digital signal processor 40. In the depicted example, the functional block 41 is not integrated in the MMIC 100 but rather in an external signal processor or microcontroller. The functional block 41 may be implemented by a software (e.g., firmware) program, which is executed by one or more processors or processor cores. In some implementations, the functional block may include hard-wired logic circuits in addition to the software executed by a processor. Herein, the functional block 41 encompasses any combination of hardware and software which is configured to perform the functions described herein.

In the previous example of FIG. 5, the initial calibration information (e.g., the initial values stored in the memory 53) is retrieved from an external circuit (e.g., the system controller 70) via the control registers 52. In the present implementation of FIG. 6, the functional block 41 (which may be part of the digital signal processor 40) can also write/update the calibration information stored in the memory 53 (e.g., by writing/updating the data contained in the control registers 52 which may then be copied to memory 53).

In the second, external calibration loop, the calibration information stored in the memory 53 is updated (e.g., via the control registers 52 and a digital communication link 61) by the functional block 41, which receives the digital radar signals y[n] from one or more RX channels, e.g., via communication link 60, and transforms these time-domain signals into the frequency-domain (in particular into the Doppler Domain by performing a two-stage Fourier Transform) to obtain transformed radar data. As explained above, the transformed radar data may include information concerning objects (radar targets) present in the field of view of the radar sensor/system. The functional block 41 then determines calibration data based on the transformed radar data and causes an update of the calibration information stored in the memory 53 of the MMIC 100 based on the calibration data. The calibration data may further depend on the known physical set-up of the antenna system, for example one or more known distances between individual antennas. This information about the physical set-up (e.g., distances) may then be used in the external calibration loop (e.g., in the calculations performed by the functional unit 41).

The calibration information stored in the memory 53 may be different dependent on which calibration loop is used. For example, first calibration information may be used when the first (internal) calibration loops is active, and second calibration information may be used, when the second (external) calibration loop is active. In one implementation, a two-stage calibration may be used. In this case, the first and the second calibration information may relate to the same physical parameter (e.g., a phase). For example, an initial calibration may be performed during startup of the radar system using the internal calibration loop and a re-calibration may be regularly during operation using the external calibration loop.

As mentioned above, the signal processor 40, which implements the functional block 41, may have a significant computational power, which enables complex and computationally intensive calibration techniques. Suitable calibration techniques are known in the art and thus not discussed in more detail herein. To give an example, reference is made to the IEEE publication Mayeul Jeannin et al., “An Iterative Phase Shifters Online Calibration Technique for Automotive Radar Systems”, in: Proc. of the 19th European Radar Conference (EuRAD), Sep. 28-30, 2022, DOI: 10.23919/EuRAD54643.2022.9924728. In particular, the calculation of the calibration data includes the transformation of the digital (time-domain) radar signals provided by the RX channels into the Doppler Domain, and calibration data is determined based on the Doppler-domain signals. For this purpose, the time domain signal is transformed into the Frequency domain using a two-stage Fourier transform, wherein the Fast Fourier transform (FFT) algorithm is normally used. The first transform is usually referred to as “range FFT” (R-FFT) and the second transform is usually referred to as “Doppler FFT” (D-FFT). As mentioned, the concept of Range-Doppler signal processing is as such known in the Field of Radar and thus not discussed herein in more detail.

The implementations described above are now further discussed and summarized with reference to the flow chart of FIG. 7. The flow chart of FIG. 7 illustrates a calibration method for a radar system, e.g., the system shown in FIG. 6. In the depicted implementation the method includes storing first and second calibration information for the radar frontend circuit in a memory of the radar system (see FIG. 7, box S1). The radar frontend circuit includes a transmission channel and a reception channel (see, e.g., FIG. 4, channels TX1 and RX1). Therein, the transmission channel transmits an RF transmit signal s_{RF}(t) and the reception channel receives an RF radar signal y_{RF}(t), which is based on the RF transmit signal s_{RF}(t). For example, the received RF radar signal y_{RF}(t) may include echoes of the RF transmit signal s_{RF}(t) reflected by objects present in the field of view of the system The reception channel also provides a digital radar signal y[n], which is based on the received RF radar signal y_{RF}(t). For example, the digital radar signal y[n] may carry substantially the same information as the received RF radar signal y_{RF}(t) after down-conversion into the base band and some preprocessing in the base band (cf. FIG. 4).

According to the flow chart of FIG. 7, the method includes operating the radar system (and in particular the radar frontend) using the stored first and/or second calibration information (see FIG. 7, box S2), and updating the first calibration information based on the RF radar signal y_{RF}(t), for example, based on the digital radar signal y[n] (see FIG. 7, box S3). Alternatively, the first calibration information may be updated based on a test signal fed into the RF signal path or the analog base-band signal processing chain of an RX channel. The updating of the first calibration information affects the operation of the radar frontend and, therefore, the process is referred to as calibration loop. Step S3 is performed by a calibration circuit (see FIG. 6, calibration circuit 51), which resides in the same MMIC as the radar frontend. Therefore, this calibration loops is referred to as internal calibration loop.

The flow chart of FIG. 7 also illustrates the transmission of the digital radar signal y[n] to a digital signal processor via a digital communication link (see FIG. 7, box S4, see also FIG. 6, communication link 60, functional block 41). The digital signal processor then transforms the digital radar signal y[n] into the Doppler domain to obtain transformed radar data (see FIG. 7, box S5) and determines calibration data based on the transformed radar data (see FIG. 7, box S6). Finally, the digital signal processor cause (e.g., via the mentioned communication link or any other communication link) an update of the second calibration information stored in the memory based on the calibration data (see FIG. 7, box S7). The updating of the second calibration information may also affect the operation of the radar frontend and, therefore, the process is referred to as external calibration loop. This calibration loop is external, because the signal processor (or parts thereof) is not integrated in the same MMIC as the radar frontend. As discussed further above, any entity (combination of hardware and software) which is configured to perform the functions shown in boxes S5-S7 of FIG. 7 may be considered a digital signal processor (see also FIG. 6, functional block 41).

The first and second calibration information may include phase values that may be used to control phase shifters arranged in the transmission and/or reception channels of the radar frontend. The phase shifter 105 shown in FIG. 4 is merely an example. Further, the first and second calibration information may include gain values that may be used to control gain of amplifiers arranged in the transmission and/or reception channels of the radar frontend (e.g., LNAs arranged in the transmission channel(s) or amplifiers included in the base-band signal processing chain, see FIG. 4).

The first and the second calibration information may relate to the same or partially the same physical parameters. However, this is not necessarily the case. For example, the first calibration information may include phase values that are updated using the internal calibration loop, whereas the second calibration information may include gain values that are updated using the external calibration loop (no overlap). In some implementations, the second calibration information may include some phase values that are also included in the first calibration information (partial overlap). In the latter example, the phase values may be calibrated by both, the internal and the external calibration loop (e.g., in a two stage calibration process). In one example, the second calibration information may be the same as the first calibration information (full overlap). In this example the same information may be calibrated by both, the internal and the external calibration loop.

In one implementation, the first calibration information (updated by the first calibration circuit 51, see FIG. 6) includes phase values for a first group of phase shifters and/or amplifiers included in the radar frontend, while the second calibration information (updated by the functional block 41 of the digital signal processor 40, see FIG. 6) includes phase values for a second group of phase shifters and/or amplifiers included in the radar frontend. The first and the second groups may overlap.

In some implementations the memory (see, e.g., FIG. 6, memory 53) may be selectively controllable/accessible such that a first portion of the memory, which stores the first calibration information, is only accessible by the first calibration circuit (see, e.g., FIG. 6, circuit 51) and a second portion of the memory, which stores the second calibration information, is only accessible by the digital signal processor (e.g., via control registers 52, see FIG. 6).

It is again emphasized that, according to one or more implementations described herein, the first (internal) calibration circuit 51 (see FIG. 6) is configured to update the first calibration information using only signals generated in the MMIC (e.g., not received from another chip). The digital signal processor included in the second (external) calibration loop can consider the whole signal path through which the radar signal travels, including the path from a transmit antenna to a radar target and back to a reception antenna. Therefore, the calibration data based on signals that have actually been radiated by an antenna of the radar system. In contrast, in the internal calibration loop, crosstalk between transmit and reception antennas may be used, or a scaled version of the transmit signal s_{RF}(t) may be fed into a reception channel (as test signal) using directional couples for the purpose of calibration using the internal calibration loop.

Although the implementation has been illustrated and described with respect to one or more implementations, alterations and/or modifications may be made to the illustrated examples without departing from the spirit and scope of the appended claims. In particular regard to the various functions performed by the above described components or structures (units, assemblies, devices, circuits, systems, etc.), the terms (including a reference to a “means”) used to describe such components are intended to correspond—unless otherwise indicated—to any component or structure, which performs the specified function of the described component (e.g., that is functionally equivalent), even though not structurally equivalent to the disclosed structure, which performs the function in the herein illustrated example implementations of the implementation.

### ASPECTS

The following provides an overview of some Aspects of the present disclosure:
Aspect 1: A radar system comprising: a first circuit including a transmission channel and a reception channel; the transmission channel being configured to transmit an RF transmit signal and the reception channel being configured to receive a radio frequency (RF) radar signal, which is based on the RF transmit signal, and to provide a digital radar signal, which is based on the received RF radar signal; memory for storing first calibration information and second calibration information for the first circuit; a first calibration circuit that is configured to update the first calibration information based on the digital radar signal; and a digital signal processor configured to receive, via a digital communication link, the digital radar signal, and to transform the digital radar signal into a Doppler domain to obtain transformed radar data, and wherein the digital signal processor is further configured to determine calibration data based on the transformed radar data and to cause an update of the second calibration information stored in the memory based on the calibration data.
Aspect 2: The radar system of Aspect 1, wherein the first circuit, the memory, and the first calibration circuit are integrated in a monolithic microwave integrated circuit (MMIC), and wherein the digital signal processor is integrated in a semiconductor chip separate from the MMIC.
Aspect 3: The radar system of any of Aspects 1-2, wherein the radar system is a cascaded radar system including a first MMIC and a second MMIC and wherein the transmission channel is integrated in the first MMIC and the reception channel is integrated in the second MMIC.
Aspect 4: The radar system of any of Aspects 1-3, wherein at least one of the first and the second calibration information includes phase information to control a phase shifter arranged in the first circuit.
Aspect 5: The radar system of any of Aspects 1-4, wherein at least one of the first and the second calibration information includes gain information to control the gain of an amplifier arranged in the first circuit.
Aspect 6: The radar system of Aspect 2, wherein the first calibration circuit is configured to update the first calibration information using only signals generated in the MMIC.
Aspect 7: The radar system of any of Aspects 1-6, wherein the digital signal processor is configured to determine the calibration data based on signals that have been radiated by an antenna of the radar system.
Aspect 8: The radar system of any of Aspects 1-7, wherein the calibration data determined by the digital signal processor considers a complete signal path through transmit and receive channels.
Aspect 9: The radar system of any of Aspects 1-8, wherein at least one of the first calibration information or the second calibration information is phase information, and wherein the transmission channel is configured to adjust a phase of at least one of the transmit signal or the received RF radar signal based on the phase information.
Aspect 10: The radar system of any of Aspects 1-9, wherein the transmission channel is configured to generate the transmit signal based on a local oscillator signal; and wherein the first calibration circuit is configured to determine the calibration information based on a fraction of the transmit signal fed into the reception channel.
Aspect 11: The radar system of any of Aspects 1-10, wherein the memory is selectively controllable such that a first portion of the memory storing the first calibration information is only accessible by the first calibration circuit and a second portion of the memory storing the second calibration information is only accessible by the digital signal processor.
Aspect 12: A method comprising: storing first calibration information and second calibration information for a first circuit of a radar system in a memory of the radar system, the first circuit including a transmission channel and a reception channel, wherein the transmission channel transmits a radio frequency (RF) transmit signal, and wherein the reception channel receives an RF radar signal, which is based on the RF transmit signal, and provides a digital radar signal; updating the first calibration information based on the digital radar signal using a first calibration circuit; transmitting, via a digital communication link, the digital radar signal to a digital signal processor; transforming the digital radar signal into a Doppler domain by the digital signal processor to obtain transformed radar data; and determining, by the digital signal processor, calibration data based on the transformed radar data and causing an update of the second calibration information stored in the memory based on the calibration data.
Aspect 13: The method of Aspect 12, further comprising: feeding a test signal into the reception channel during a first calibration procedure so that the digital radar signal is based on the test signal, wherein the first calibration information is updated during the first calibration procedure.
Aspect 14: The method of any of Aspects 12-13, wherein, during a second calibration procedure the digital radar signal is based on a received RF radar signal, and wherein the second calibration information updated during the second calibration procedure.
Aspect 15: The method of any of Aspects 12-14, wherein at least one of the first and the second calibration information includes at least one of gain information or phase information used for controlling at least one of an amplitude of a phase of at least one of the RF transmit signal or the received RF radar signal.
Aspect 16: A system configured to perform one or more operations recited in one or more of Aspects 1-15.
Aspect 17: An apparatus comprising means for performing one or more operations recited in one or more of Aspects 1-15.
Aspect 18: A non-transitory computer-readable medium storing a set of instructions, the set of instructions comprising one or more instructions that, when executed by a device, cause the device to perform one or more operations recited in one or more of Aspects 1-15.
Aspect 19: A computer program product comprising instructions or code for executing one or more operations recited in one or more of Aspects 1-15.

1. A radar system comprising:
a first circuit including a transmission channel and a reception channel; the transmission channel being configured to transmit an RF transmit signal and the reception channel being configured to receive a radio frequency (RF) radar signal, which is based on the RF transmit signal, and to provide a digital radar signal, which is based on the received RF radar signal;
memory for storing first calibration information and second calibration information for the first circuit;
a first calibration circuit that is configured to update the first calibration information based on the digital radar signal; and
a digital signal processor configured to receive, via a digital communication link, the digital radar signal, and to transform the digital radar signal into a Doppler domain to obtain transformed radar data, and
wherein the digital signal processor is further configured to determine calibration data based on the transformed radar data and to cause an update of the second calibration information stored in the memory based on the calibration data.

2. The radar system of claim 1, wherein the first circuit, the memory, and the first calibration circuit are integrated in a monolithic microwave integrated circuit, and
wherein the digital signal processor is integrated in a semiconductor chip separate from the MMIC.

3. The radar system of claim 1, wherein the radar system is a cascaded radar system including a first monolithic microwave integrated circuit (MMIC) and a second MMIC and
wherein the transmission channel is integrated in the first MMIC and the reception channel is integrated in the second MMIC.

4. The radar system of claim 1, wherein at least one of the first and the second calibration information includes phase information to control a phase shifter arranged in the first circuit.

5. The radar system of claim 1, wherein at least one of the first and the second calibration information includes gain information to control the gain of an amplifier arranged in the first circuit.

6. The radar system of claim 2, wherein the first calibration circuit is configured to update the first calibration information using only signals generated in the MMIC.

7. The radar system of claim 1, wherein the digital signal processor is configured to determine the calibration data based on signals that have been radiated by an antenna of the radar system.

8. The radar system of claim 1, wherein the calibration data determined by the digital signal processor considers a complete signal path through transmit and receive channels.

9. The radar system of claim 1, wherein at least one of the first calibration information or the second calibration information is phase information, and
wherein the transmission channel is configured to adjust a phase of at least one of the transmit signal or the received RF radar signal based on the phase information.

10. The radar system of claim 1, wherein the transmission channel is configured to generate the transmit signal based on a local oscillator signal; and
wherein the first calibration circuit is configured to determine the calibration information based on a fraction of the transmit signal fed into the reception channel.

11. The radar system of claim 1, wherein the memory is selectively controllable such that a first portion of the memory storing the first calibration information is only accessible by the first calibration circuit and a second portion of the memory storing the second calibration information is only accessible by the digital signal processor.

12. A method comprising:
storing first calibration information and second calibration information for a first circuit of a radar system in a memory of the radar systemm, the first circuit including a transmission channel and a reception channel, wherein the transmission channel transmits a radio frequency (RF) transmit signal, and wherein the reception channel receives an RF radar signal, which is based on the RF transmit signal, and provides a digital radar signal;
updating the first calibration information based on the digital radar signal using a first calibration circuit;
transmitting, via a digital communication link, the digital radar signal to a digital signal processor;
transforming the digital radar signal into a Doppler domain by the digital signal processor to obtain transformed radar data; and
determining, by the digital signal processor, calibration data based on the transformed radar data and causing an update of the second calibration information stored in the memory based on the calibration data.

13. The method of claim 12, further comprising:
feeding a test signal into the reception channel during a first calibration procedure so that the digital radar signal is based on the test signal, wherein the first calibration information is updated during the first calibration procedure.

14. The method of claim 12, wherein, during a second calibration procedure the digital radar signal is based on a received RF radar signal, and
wherein the second calibration information updated during the second calibration procedure.

15. The method of claim 12, wherein at least one of the first and the second calibration information includes at least one of gain information or phase information used for controlling at least one of an amplitude of a phase of at least one of the RF transmit signal or the received RF radar signal.
